(19) United States
(12) Patent Application Publication
(10) Pub. No.: US 2005/0236557 A1
(43) Pub. Date: Oct. 27, 2005

(54) Portable photo-controlled electrical power apparatus

(76) Inventor: Jon R. Hurst, Pageland, SC (US)

Correspondence Address: F. RHETT BROCKINGTON, 4808-101 ALEXANDER VALLEY DRIVE, CHARLOTTE, NC, 28270, US

(21) Appl. No.: 10/831,792

(22) Filed: Apr. 26, 2004

(51) Int. Cl. H01J 40/14

(52) U.S. Cl. 250/214 R; 250/214 AL

(57) ABSTRACT

The invention is a portable photo-controlled electrical power apparatus that is responsive to daylight. The apparatus consists of: an outdoor grounded electrical plug connected by an electrical chord to an outdoor electrical receptacle having at least one socket. The receptacle is fitted with a sealed photo-controller. When the photo-controller does not detect ambient light, the switch is open and the receptacle is not electrified. When the light approaches nighttime, then the switch of the photo-controller electrifies the receptacle. In most embodiments, it is anticipated that the outdoor grounded electrical chord will be relatively short, so that the apparatus can be used in combination with a conventional extension chord if one is required. The invention preferably includes a dimmer for manually controlling how much light reaches the photo-controller. The dimmer can be set so all the ambient light is blocked, or set so that a percentage of the light is blocked. The invention also includes a tiltable stand. The tiltable stand elevates the receptacle and enables the receptacle to be tilted. Orientation can prevent feedback to the photo-controller from the lights that are activated at night, or to compensate for seasonal variations in the path of the sun, or to accommodate for unevenness in the ground surface.

### BACKGROUND OF THE INVENTION

1. Field of the Invention

The invention relates generally to a photo-controlled electrical device, and more particularly to an outdoor electrical power chord that can be set to provide power only during conditions of nighttime lighting or be set to provide power under all lighting conditions.

2. Prior Art

Numerous photo-controllers have been invented to automatically switch on streetlights and floodlights at dusk, and to switch them off at dawn. In 1963, Collier disclosed, in U.S. Pat. No. 3,081,411, a photoelectric street lamp control that prevents the accidental initiation of a mercury vapor lamp when, for instance, a cloud passes overhead. Numerous other devices have been invented to protect against accidental initiation or deactivation, when light generated by the controlled lamp is sufficient to provide feedback light, therein causing the photo-controller to incorrectly sense daylight, and to switch power off. Strobe lights have been invented, which utilize the feed back phenomena between source and photo-controller. A common feature in the prior art is that the photo-controllers and the devices that they control are static, that is they are mounted on a pole or otherwise occupy a constant position. Typically, the photo-controller is hooded and has a known, constant orientation. Often the photo-controllers are used in combination with a timer, to prevent the premature detection of nighttime. A second common feature of the prior art is that most photo-controllers are dedicated to a device. The controllers are typically integral to the device, for instance a lamp or a relay controlling a series of lights. What is needed is a photo-controlled electrical power apparatus that is portable, and can be quickly added to an electrical power source, thereby adding photo-control to the electrical power source. Examples of electrical power sources are an electrical outlet or an extension chord. Further what is needed is a photo-controlled electrical power apparatus that can be used outdoors that will operate dependably under a variety of weather and daylight conditions. Also what is needed is a photo-controlled electrical power apparatus that can be easily be tested to confirm that the photo-controller is operating properly, as evidenced by the proper operation of the controlled device (i.e., lamp) and its associated electrical circuit. The invention disclosed herein provides a solution for each of these needs. Anticipated applications for the invention include outdoor seasonal flood lights and spot lights, outdoor Christmas tree lights and motorized decorations, constructions site lighting, and temporary safety/security lighting.

### SUMMARY OF THE INVENTION

The invention is a portable photo-controlled electrical power apparatus that is responsive to daylight. The apparatus is comprised of: an outdoor grounded electrical plug; an outdoor grounded electrical receptacle having at least one socket; an outdoor grounded electrical chord having a ground wire, a neutral wire and line wire; and a sealed photo-controller having a switch controlled by a photo-cell and a means for activating the switch when there is very little daylight. The receptacle has a top surface, a bottom surface and side walls. The photo-sensor is mounted in the top surface. The photo-controller is wired across the line wire and the neutral wire such that the switch controls electrical flow through the line wire. When the photo-controller does not detect ambient light, the switch is open and the sockets in the receptacle are not electrified. When the brightness of the ambient light approaches a flux level of nighttime, the switch of the photo-controller closes, and the sockets controlled by photo-controller become electrified. Not all the sockets need be controlled by the photo-controller. In most embodiments, it is anticipated that the outdoor grounded electrical chord will be relatively short, so that the apparatus can be used in combination with a conventional extension chord if one is required. The invention preferably includes a dimmer for manually restricting what percentage of the ambient light reaches the photo-cell. The dimmer can be set so all the ambient light is blocked, or set so that a discrete percentage of ambient light reaches the photo-cell. When all the ambient light is blocked, the apparatus acts as a conventional extension chord. This setting can be useful when using the apparatus as an ordinary chord, and as means of testing the circuit to simulate darkness. The invention also preferably includes a tiltable stand. The tiltable stand elevates the receptacle off the ground, and enables the receptacle to be oriented. Orientation is desired because it can prevent feedback to the photo-cell from the lights that are activated at night, or oriented so that the photo-cell is aimed roughly north or south to compensate for seasonal variations in the path of the sun, or oriented to accommodate unevenness in the ground surface. The tiltable stand also makes the receptacle less subject to being in a pool of water following a rainfall. In a simple but effective embodiment the stand attaches to the bottom of the receptacle.

In a typical application the portable photo-controlled electrical power apparatus is used to control Christmas tree lights such that they turn on at night. In daylight, the plug of the apparatus is plugged into an electrical power source. The plugs of the Christmas tree lights are plugged into the receptacle and the dimmer is turned to where all ambient light is blocked. After about 30 to 120 second delay, the switch is activated and turns on the lights. The dimmer is then set to where 100% percent of ambient light reaches the photo-cell. In the evening, after the lights come on, if they shut back off then there is too much feedback light from the Christmas tree lights to the photo-cell. The receptacle should be angled so that the photo-cell doesn't see as much illumination from the lights. If it is desired that the lights come on earlier, then the dimmer can be turned down to a lower percentage, thereby restricting the available quantity of ambient light and initiating the perception of earlier nightfall.

### BRIEF DESCRIPTION OF THE DRAWINGS

FIG. 1 is a perspective view of the invention, a portable photo-controlled electrical power apparatus.

FIG. 2 is a circuit diagram of the portable photo-controlled electrical power apparatus.

FIG. 3 is a circuit diagram of the photo-controller shown in FIG. 2.

FIG. 4 is an enlarged perspective view of the receptacle of the apparatus, wherein the receptacle has a dimmer.

FIG. 5 is an exploded view of the tiltable stand.

FIG. 6 is a perspective view of the portable photo-controlled electrical power apparatus fitted with a dimmer and a tiltable stand.

### DETAILED DESCRIPTION OF THE INVENTION

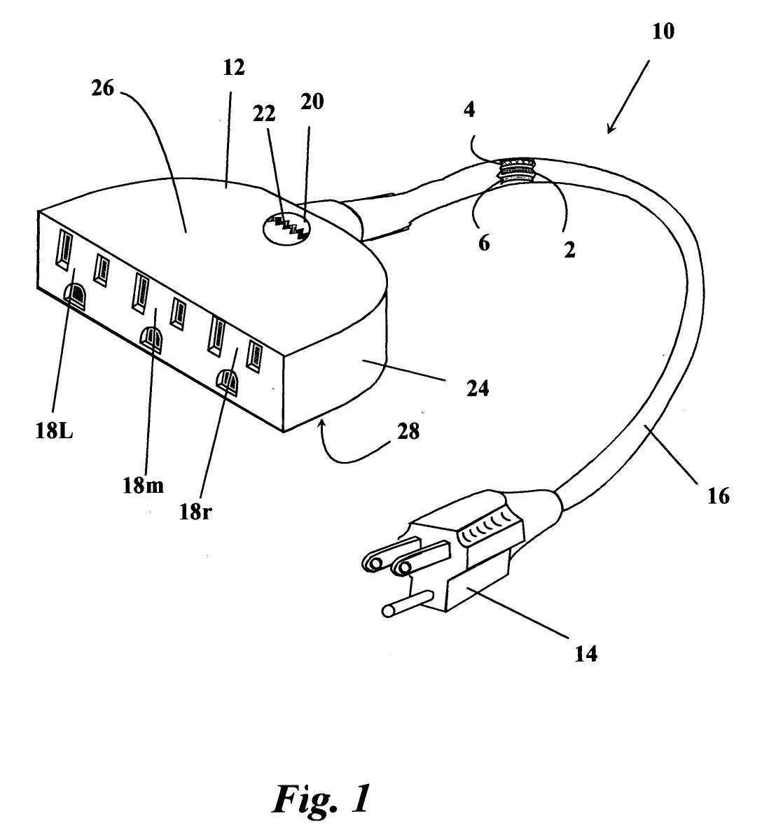

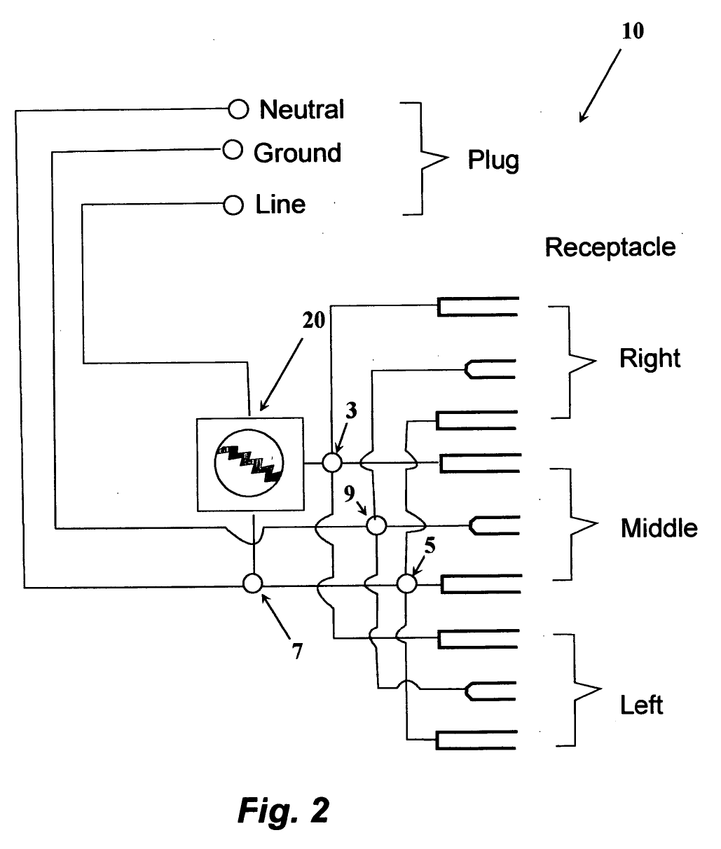

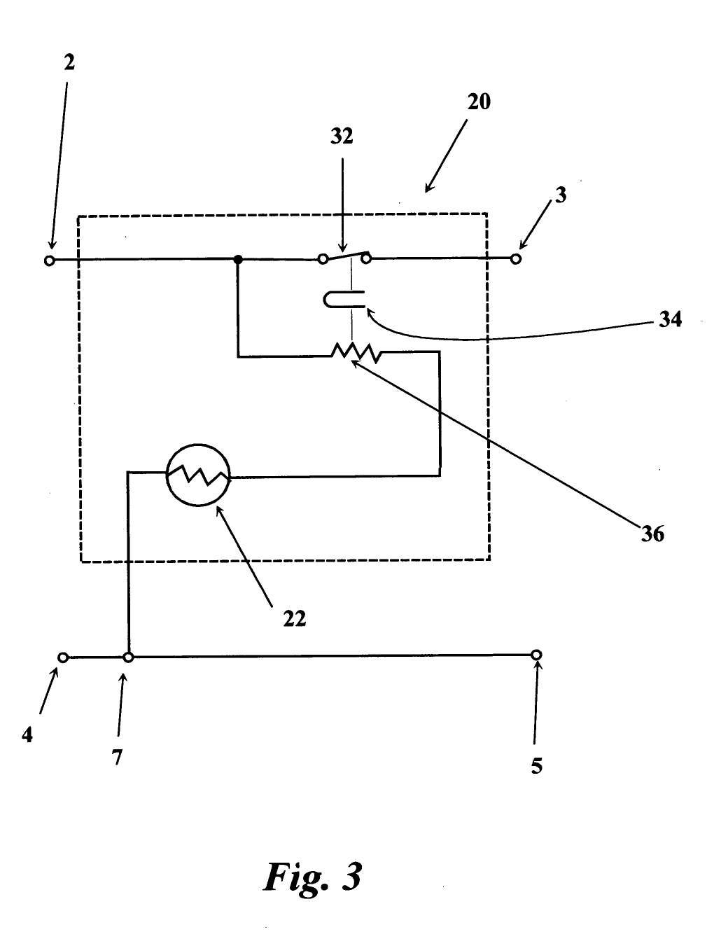

An embodiment of the portable photo-controlled electrical power apparatus 10 is illustrated in FIG. 1. The apparatus 10 is comprised of: an outdoor grounded electrical plug 14; an outdoor grounded electrical receptacle 12 having at least one socket 181, 18m and 18r; an outdoor grounded electrical chord 16 having a ground wire 6, a neutral wire 4 and line wire 2; and a sealed photo-controller 20 having a switch controlled by a photo-cell 22 and a means for activating the switch when there is very little daylight. The receptacle has a top surface 26, a bottom surface 28 and side walls 24. The photo-cell 22 is mounted in the top surface 26. In the illustrated embodiment, the receptacle 12 has three sockets 18L, 18m and 18r, where the letters L, m, and r refer to left, middle and right, respectively. Referring to FIG. 2, which is a circuit diagram of the portable photo-controlled electrical power apparatus, the photo-controller 20 is wired across the line wire 2 (see FIG. 1) and the neutral wire 4 (see FIG. 1) such that the switch controls electrical flow through the line wire. When the photo-controller detects ambient light, the switch is open and the sockets in the receptacle are not electrified. When the brightness of the ambient light approaches a flux level of nighttime, then the switch of the photo-controller closes, and the sockets become electrified. The line wire 2 is in electrical connection with all three sockets of the receptacle at junction 3. The neutral wire 4 is connected to the sockets at junction 5, and the ground wire 6. The photo-controller 20 is connected to the line power and to the neutral wire 4 at junction 7. The circuit of the photo-controller is dependent on the selection of the photo-conductor and the switching mechanism, as well as the employment of various protective circuits (i.e., fuses, circuit breakers, type of switch, surge protection devices). In the illustrated embodiment the photo-controller is photo-conductor type which typically employs a cadmium sulfide (CdS), cadmium selenide (CdSe) or combination of the two (CdS-CdSe). These materials (e.g., cadmium sulfide, cadmium selenide) are sensitive to visible-light in 0.6 micron range for CdS and 0.72 microns for CdSe. It is anticipated that the preferred photo-conductor could be lead sulfide (PbS) or lead selenide (PbSe) for their sensitivity in the IR range (2.2 to 3.6 micron range). The switch is preferably a thermal bimetallic type. The photo-controller is preferably selected for internal mounting, and is constructed having a durable UV stabilized polycarbonate housing. The wire leads exit from the rear allowing the photo-controller to be placed in tight locations while positioning the wiring for easy access. The photo-controller includes a brushed aluminum wall plate for installation in standard outlet boxes. The photo-controller utilizes a heavy-duty thermal bimetal switch that provides a 30-45 second minimum time delay. It is anticipated that the controller can also have a metal oxide varistor (MOV) to protect the apparatus against transient voltage surges. The switch is a SPST (single pole single throw type) thermal bimetallic. The contacts are normally closed in the fail mode, that means that the receptacle is electrified. Power consumption is about 0.9 Watts (avg.) @ 120 volts. The operating temperature range −40° C. to +65° C. at 96% Relative Humidity. The photo-cell is comprised of cadmium sulfide (CdS). One supplier for this type of photo-controller is Tyco@. FIG. 3 illustrates circuit diagram of the photo-controller 20. The photo-cell 22 is in series with a heating resistor 36, and connected to the line wire 2. The electrical resistance is low across the photo-cell when the visible light illumination is high, and the resistance is high as the illumination decreases. Therefore, when there is little light, current is lower through the heating resistor 36, and less heat is generated. The lower heat causes the bimetallic element 34 to curl inward, as shown in FIG. 3, the circuit is closed, and the receptacle is electrified.

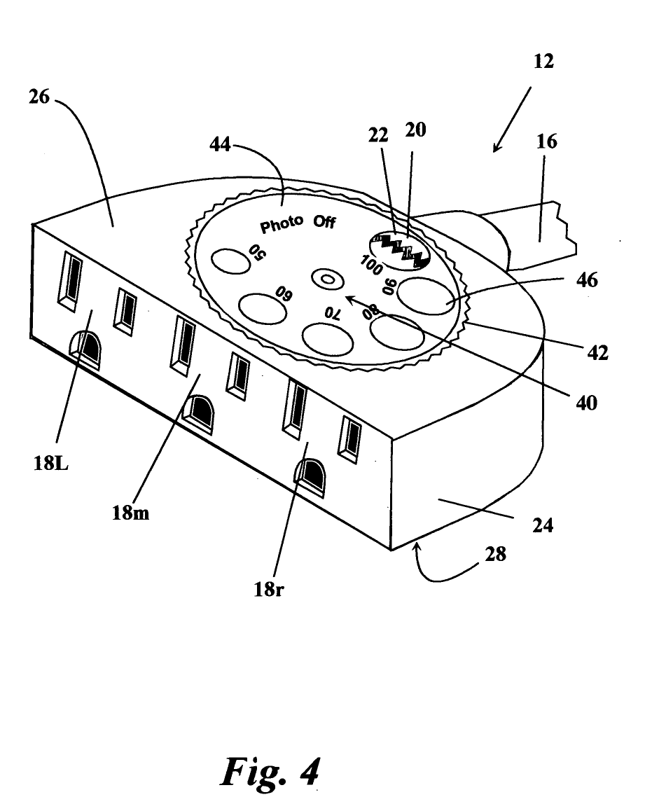

The embodiment also includes a light selection dimmer 40 for selecting what percentage of the available ambient light reaches the photo-cell 22. The dimmer 40 is illustrated in FIG. 4. The dimmer 40 is a manually controlled thumb wheel 42 with multiple light transparent openings 46 and a light blocking shield 44. In the illustrated embodiment, there are six light transparent openings which are aligned with the photo-cell. As shown in FIG. 4, the opening that transmits 100% of the available light is centered over the photo-cell. The openings 46 are labeled as to how much light is transmitted. The first opening transmits about 100% of the ambient light, a second opening transmits about 90% of the ambient light, a third opening transmits about 80% of the ambient light, a fourth opening transmits about 70% of the ambient light, a fifth opening transmits about 60% of the ambient light, and a sixth opening transmits about 50% of the ambient light. The thumb wheel 42 is mounted on the top surface 26 of the receptacle 12. The thumb wheel 42 can be rotated substantially freely, until the desired light transparent opening 46, or the light blocking shield 44 is properly aligned with the photo-cell 22, at which point the thumb wheel clicks into position, therein assuring that proper alignment is attained. The dimmer 40 can be set so that all the ambient light is blocked, or set so that a discrete percentage of ambient light reaches the photo-cell 22. When all the ambient light is blocked, the apparatus 10 acts as a conventional extension chord. This setting can be useful when using the apparatus as an ordinary chord, and as means of testing the circuit to simulate darkness.

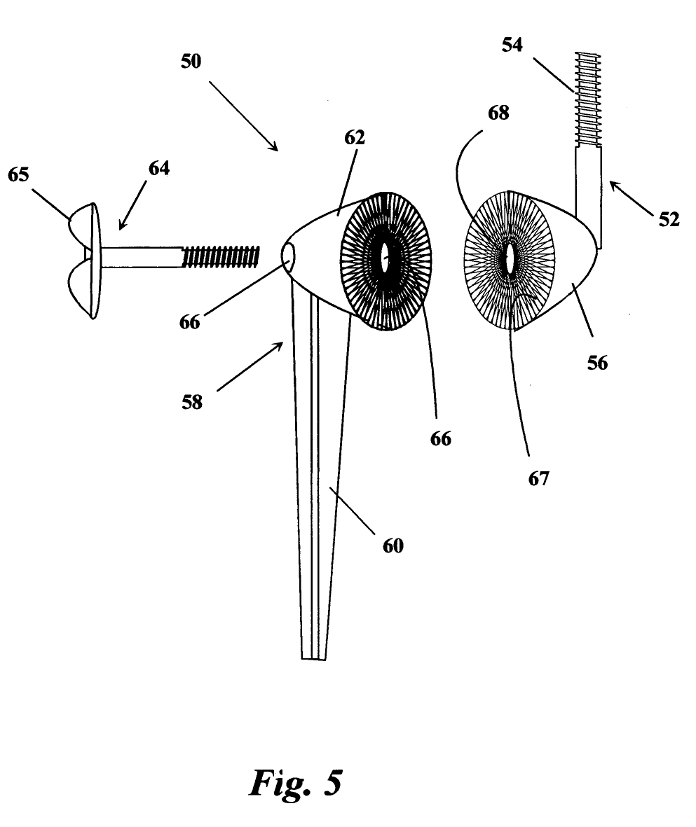

The illustrated embodiment of the invention includes a tiltable stand 50, as shown in FIG. 5 in an exploded view. The tiltable stand 50 interfaces with the bottom side 26 of the receptacle 12 and the ground surface 1. The tiltable stand 50 elevates the receptacle 12 and enables the orientation of the receptacle to be adjusted irrespective of the levelness of the ground surface 1. The tiltable stand 50 comprises a rotatable element 52 having a fastening component 52 for connecting to the receptacle 12 and having a first adjustable coupling 56. In the illustrated embodiment the fastening component 54 is a threaded rod, which can screw into the bottom of the receptacle 12. The tiltable stand 50 also has a stationary element 58 having at least one leg 60 for intersecting the ground 1 and having a matching second adjustable coupling 62. The tiltable stand 50 is further comprised of a tightening-linking element 54 that connects and tightens the first adjustable coupling 56 to the matching second adjustable coupling 62. The tightening-linking element 54 is substantially a bolt with a wing nut 65 to allow hand fastening. The matching second adjustable coupling 62 has an open channel 66, and the first adjustable coupling 56 has a threaded channel 68. The faces of both couplings, 56 and 62, are radially ridged 67 so as to prevent slippage and quick adjustment. The leg 60 is at least partially tapered so that it can be hand forced into the ground, therein enabling the stationary element 50 to be free standing.

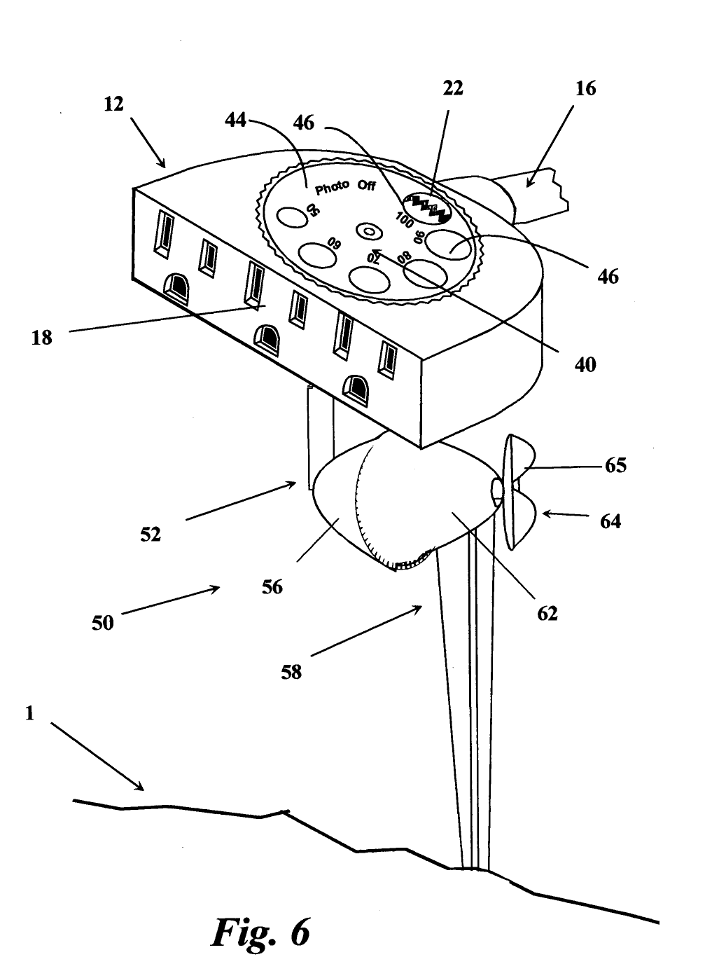

FIG. 6 is a perspective view of the portable photo-controlled electrical power apparatus 10 (less the plug) fitted with the dimmer 40 and the tiltable stand 50 embedded in the ground 1. The tiltable stand elevates the receptacle off the ground, and enables the receptacle to be oriented.

In a typical application the portable photo-controlled electrical power apparatus 10 is used to control Christmas tree lights such that they turn on at night. In daylight, the plug 14 of the apparatus 10 is plugged into an electrical power source. The plugs of the Christmas tree lights are plugged into the sockets 18 (e.g., 18L, 18m, and 18r) of the receptacle 12. The dimmer 40 is turned to where all ambient light is blocked, the light shield 44 is covering the photo-cell 22. After about 30 to 120 second delay, the switch turns on the lights. The dimmer 40 is then set to where 100% percent of the ambient light reaches the photo-cell 22. In the evening, when the lights come on, if they shut back off then there is too much feedback light from the Christmas tree lights, and the receptacle 12 should be tilted so that the photo-cell 22 doesn't see as much illumination from the lights. If it is desired that the lights come on earlier, then the dimmer 40 can be turned down to a lower percentage, thereby restricting the available quantity of ambient light and initiating the perception of earlier nightfall.

As various possible embodiments might be made of the above invention, and as various changes might be made in the embodiments above set forth, it is understood that all matters herein described or shown in the accompanying drawings are to be interpreted as illustrative and not limiting.

1. A portable photo-controlled electrical power apparatus that is electrified depending upon an intensity of ambient light, said apparatus comprising:
an outdoor grounded electrical plug;
an outdoor grounded electrical receptacle having at least one socket;
an outdoor grounded electrical chord having a ground wire, a neutral wire and line wire;
a sealed photo-controller having a switch controlled by a photo-cell and a means for activating the switch when there is very little ambient light;
wherein said grounded electrical chord connects said electrical plug to said electrical receptacle;
wherein said receptacle has a top surface, a bottom surface and side walls;
wherein said photo-sensor is mounted in the top surface;
wherein said photo-controller is wired across the line wire and the neutral wire such that said switch controls electrical flow through the line wire; and
wherein the at least one socket is electrified when said switch is activated.

2. The portable photo-controlled electrical power apparatus as claimed in claim 1, wherein said photo-cell is a photo-conductor.

3. The portable photo-controlled electrical power apparatus as claimed in claim 2, wherein said photo-conductor is comprised of cadmium sulfide.

4. The portable photo-controlled electrical power apparatus as claimed in claim 2, wherein said switch is a single pole single throw (SPST) thermal bimetallic switch.

5. The portable photo-controlled electrical power apparatus as claimed in claim 4, wherein the means for activating the switch is a heating resistor.

6. A portable photo-controlled electrical power apparatus according to claim 1, further comprising a light selection dimmer, wherein said dimmer determines the percentage of ambient light that reaches the photo-cell.

7. The portable photo-controlled electrical power apparatus as claimed in claim 6, wherein said dimmer is a manually controlled thumb wheel with at least one light transparent opening and a light blocking shield, where said at least one light transparent opening is aligned with the photo-cell therein allowing a discrete percentage of the ambient light to reach the photo-cell.

8. The portable photo-controlled electrical power apparatus as claimed in claim 7, wherein said dimmer has six light transparent openings, where a first opening transmits about 100% of the ambient light, a second opening transmits about 90% of the ambient light, a third opening transmits about 80% of the ambient light, a fourth opening transmits about 70% of the ambient light, a fifth opening transmits about 60% of the ambient light, and a sixth opening transmits about 50% of the ambient light.

9. The portable photo-controlled electrical power apparatus as claimed in claim 7, wherein said thumb wheel is a mounted on the top surface of said receptacle, and wherein the thumb wheel substantially rotates freely until at least one light transparent opening or the light blocking shield is properly aligned with the photo-cell, at which point the thumb wheel clicks into position.

10. A portable photo-controlled electrical power apparatus according to claim 1, further comprising a tiltable stand, where said tiltable stand interfaces with the bottom side of said receptacle and a ground surface having a levelness, wherein said tiltable stand elevates the receptacle and enables the orientation of the receptacle to be adjusted irrespective of the levelness of the ground surface.

11. The portable photo-controlled electrical power apparatus as claimed in claim 10, wherein said tiltable stand comprises a rotatable element having a fastening component for connecting to the receptacle and having a first adjustable coupling; a stationary element having at least one leg for intersecting the ground and having a matching second adjustable coupling; and a tightening linking element that connects and tightens the first adjustable coupling to the matching second adjustable coupling therein establishing a fixed orientation.

12. The portable photo-controlled electrical power apparatus as claimed in claim 11, wherein the tightening linking element is a bolt with a wing nut head.

13. The portable photo-controlled electrical power apparatus as claimed in claim 11, wherein the at least one leg has a pointed end and can be hand forced into the ground, such that the stationary element is free standing.

14. The portable photo-controlled electrical power apparatus as claimed in claim 1, wherein said apparatus is used to control Christmas tree lights such that they turn on at night, by plugging the plug into an electrical power source and plugging a light chord that is electrically connected to the Christmas tree lights into the at least one socket of the receptacle.

15. The portable photo-controlled electrical power apparatus as claimed in claim 5, wherein the resistance across the photo-cell decreases as the ambient light increases, so that as the ambient light decreases the heating resistance gets hotter causing the thermal bimetallic switch to flex, therein closing the circuit.

16. The portable photo-controlled electrical power apparatus as claimed in claim 2, wherein said photo-conductor is comprised of cadmium selenide.

17. The portable photo-controlled electrical power apparatus as claimed in claim 2, wherein said photo-conductor is comprised of a mix of cadmium sulfide and cadmium selenide.
